(19) United States
(12) Patent Application Publication
(10) Pub. No.: US 2026/0278729 A1
(43) Pub. Date: Sep. 17, 2026

(54) METHOD, DEVICE, AND APPARATUS, AND STORAGE MEDIUM FOR STATIC DISPLAY CONTROL FOR GPU

(71) Applicant: Moore Threads Technology Co., Ltd., Beijing (CN)

(72) Inventors: Jue YANG, Beijing (CN); Jianhong LUO, Beijing (CN); Shaoyang MA, Beijing (CN)

(21) Appl. No.: 19/675,856

(22) Filed: May 13, 2026

Related U.S. Application Data
(63) Continuation of application No. PCT/CN2024/132323, filed on Nov. 15, 2024.

(30) Foreign Application Priority Data
Nov. 16, 2023 (CN) 202311532439.4

(51) Int. Cl. G06T 1/60; G06F 1/08; G06T 1/20

(52) U.S. Cl. CPC G06T 1/60; G06T 1/20; G06F 1/08

(57) ABSTRACT

The present disclosure relates to a method, a device, an apparatus, and a storage medium for static display control for GPU. The method includes: copying frame data in a first video memory to a second video memory in response to entering a static display scenario; reading the frame data from the second video memory and displaying it; performing an adjustment of reducing a clock frequency of the first video memory; and reading the frame data from the first video memory and displaying it in response to completion of the adjustment to the clock frequency of the first video memory.

### CROSS-REFERENCE TO RELATED APPLICATION

This application is a continuation of and claims priority under 35 U.S.C. § 120 to PCT Application No. PCT/CN 2024/132323, filed on Nov. 15, 2024, which claims priority to Chinese Patent Application No. 202311532439.4, filed on Nov. 16, 2023, and entitled “Method, Device, Apparatus, and Storage Medium for static display control for GPU”. All the above referenced priority documents are incorporated herein by reference.

### TECHNICAL FIELD

The present disclosure relates to the field of computer technologies, and in particular, to a method, a device, an electronic apparatus, and a storage medium for static display control for GPU.

### BACKGROUND

A static display scenario of Graphics Processing Unit (GPU) is a typical low-power scenario for the GPU. In a static display scenario of GPU, a display reads frame data from a video memory (for example, Graphics Double Data Rate (GDDR) memory) of the GPU at a preset refresh rate and displays it. The power consumption of the video memory occupies a relatively large proportion in the overall power consumption of the GPU, and therefore, reducing the power consumption of the video memory is of great significance for reducing the overall power consumption of the GPU.

### SUMMARY

The present disclosure provides a technical solution for static display control for GPU.

According to an aspect of the present disclosure, a method for static display control for Graphics Processing Unit (GPU) is provided, comprising:
copying frame data in a first video memory to a second video memory in response to entering a static display scenario;
reading the frame data from the second video memory and displaying the frame data; and
reducing a clock frequency of the first video memory;
reading the frame data from the first video memory and displaying the frame data in response to completion of an adjustment to the clock frequency of the first video memory.

In a possible implementation, copying frame data in the first video memory to the second video memory in response to entering the static display scenario comprises:
acquiring a number of displays in response to entering the static display scenario;
determining the second video memory according to the number of the displays;
copying the frame data in the first video memory to the second video memory.

In a possible implementation, determining the second video memory according to the number of displays comprises:
determining the second video memory as a static random access memory in the GPU in response to the number of displays falling within a preset range of number.

In a possible implementation, determining the second video memory according to the number of displays comprises:
determining the second video memory as a low power double data rate (LPDDR) memory in the GPU in response to the number of displays not falling within a preset range of number.

In a possible implementation, copying the frame data in the first video memory to the second video memory comprises:
copying all the frame data in the first video memory to the static random access memory in response to a data volume of the frame data in the first video memory being less than or equal to a capacity of the static random access memory.

In a possible implementation,
copying the frame data in the first video memory to the second video memory comprises: copying first frame data in the first video memory to the static random access memory in response to a data volume of the frame data in the first video memory being greater than a capacity of the static random access memory, wherein the data volume of the first frame data is equal to the capacity of the static random access memory; and
the method also comprises copying the second frame data in the first video memory to a system memory.

In a possible implementation, the method further comprises:
copying the second frame data in the system memory to the static random access memory in response to the first frame data in the static random access memory being read out.

In a possible implementation, the static random access memory adopts a data structure of a ring buffer.

According to an aspect of the present disclosure, a device for static display control for GPU is provided, comprising:
a first copy module configured to copy frame data in a first video memory to a second video memory in response to entering a static display scenario;
a first display module configured to read the frame data from the second video memory and display the frame data; p1 a reduction module configured to reduce a clock frequency of the first video memory;
a second display module configured to read the frame data from the first video memory and display the frame data in response to completion of an adjustment to the clock frequency of the first video memory.

In a possible implementation, the first copy module is configured to:
acquire a number of displays in response to entering the static display scenario;
determine a second video memory according to the number of the displays;
copy the frame data in the first video memory to the second video memory.

In a possible implementation, the first copy module is configured to:
determine the second video memory as a static random access memory in the GPU in response to the number of displays falling within a preset range of number.

In a possible implementation, the first copy module is configured to:
determine the second video memory as a low power double data rate (LPDDR) memory in the GPU in response to the number of displays not falling within a preset range of number.

In a possible implementation, the first copy module is configured to:
copy all the frame data in the first video memory to the static random access memory in response to a data volume of the frame data in the first video memory being less than or equal to a capacity of the static random access memory.

In a possible implementation,
the first copy module is configured to copy first frame data in the first video memory to the static random access memory in response to that a data volume of the frame data in the first video memory is greater than a capacity of the static random access memory, wherein a data volume of the first frame data is equal to the capacity of the static random access memory; and
the device further comprises: a second copy module configured to copy a second frame data in the first video memory to a system memory.

In a possible implementation, the device further comprises:
a third copy module configured to copy the second frame data in the system memory to the static random access memory in response to the first frame data in the static random access memory being read out.

In a possible implementation, the static random access memory adopts a data structure of a ring buffer.

According to an aspect of the present disclosure, a device for static display control for Graphics Processing Unit (GPU) is provided, comprising a system management controller, a first video memory, a second video memory, a display engine, and a clock control module.
the system management controller is configured to copy frame data in a first video memory to a second video memory in response to the notification message for entering the static display scenario;
the display engine is configured to read the frame data from the second video memory and display the frame data; and
the clock control module is configured to reduce a clock frequency of the first video memory.
the display engine is further configured to read the frame data from the first video memory and display the frame data in response to completion of an adjustment to the clock frequency of the first video memory.

In a possible implementation, the second video memory comprises a static random access memory.

In a possible implementation, the static random access memory adopts a data structure of a ring buffer.

In a possible implementation, the second video memory comprises a LPDDR memory.

In a possible implementation, the device further comprises a direct memory access (DMA) module;
the system management controller is further configured to copy the frame data in the first video memory to the second video memory by the DMA module.

In a possible implementation, the device further comprises: p1 a static display control module configured to send a notification message for entering the static display scenario to the system management controller in response to entering the static display scenario.

In a possible implementation, the device further comprises:
a system memory configured to back up the frame data.

According to an aspect of the present disclosure, an electronic apparatus is provided, comprising: one or more processors; and a memory for storing executable instruction, wherein the one or more processors are configured to invoke the executable instruction stored in the memory to execute the above method.

According to an aspect of the present disclosure, there is provided a computer-readable storage medium having stored thereon computer program instructions that, when executed by a processor, implement the above method.

According to an aspect of the present disclosure, a computer program product is provided, comprising computer-readable code or a non-volatile computer-readable storage medium carrying computer-readable code, wherein when the computer-readable code runs in an electronic apparatus, a processor in the electronic apparatus executes the foregoing method.

In the embodiments of the present disclosure, by copying the frame data in the first video memory to the second video memory in response to entering the static display scenario, reading the frame data from the second video memory and displaying the frame data, reducing the clock frequency of the first video memory, and reading the frame data from the first video memory and displaying the frame data in response to completion of an adjustment to the clock frequency of the first video memory, the first video memory is in an idle state in the process of reading the frame data from the second video memory, so that the clock frequency of the first video memory can be reduced to reduce the overall power consumption of the GPU. In the embodiments of the present disclosure, the clock frequency of the first video memory does not need to be adjusted in the VBlank interval, that is, there is sufficient time to adjust the clock frequency of the first video memory, so that the requirements on the GPU chip can be reduced, and the flow of frequency adjustment of the first video memory does not need to be specially designed. In addition, in the embodiments of the present disclosure, the frame data in the first video memory is copied to the second video memory in the same GPU, and the frame data is read from the second video memory in the GPU in the process of adjusting the clock frequency of the first video memory, thereby reducing the dependence on external factors (such as the bandwidth of the PCIe bus and the bandwidth of the system memory) of the GPU, that is, reducing the dependence on the system hardware configuration, thereby reducing the probability of screen flickering of the display.

It is to be understood that both the foregoing general description and the following detailed description are exemplary and explanatory only and are not restrictive of the disclosure.

Other features and aspects of the present disclosure will become apparent from the following detailed description of exemplary embodiments with reference to the accompanying drawings.

### BRIEF DESCRIPTION OF DRAWINGS

The accompanying drawings, which are incorporated in and constitute a part of this specification, illustrate embodiments consistent with the present disclosure and, together with the description, serve to explain the technical solutions of the present disclosure.

FIG. 1 shows a flowchart of a method for static display control for GPU provided by the embodiments of the present disclosure.

FIG. 2 shows a schematic diagram of an application scenario of a single display in a method for static display control for GPU provided by the embodiments of the present disclosure.

FIG. 3 shows a schematic diagram of a multi-display application scenario in a method for static display control for GPU provided by the embodiments of the present disclosure.

FIG. 4 shows a block diagram of a device for static display control for GPU provided by the embodiments of the present disclosure.

FIG. 5 shows a block diagram of an electronic apparatus 800 provided by the embodiments of the present disclosure.

### DETAILED DESCRIPTION

Various exemplary embodiments, features, and aspects of the present disclosure will be described in detail below with reference to the accompanying drawings. The same reference numbers in the drawings represent functionally the same or similar elements. Although the various aspects of the embodiments are presented in drawings, the drawings are not necessarily drawn to scale unless specifically indicated.

The word “exemplary” is used exclusively herein to mean “serving as an example, embodiment, or illustration.” Any embodiment described herein as “exemplary” is not necessarily to be construed as preferred or advantageous over other embodiments.

The term “and/or” in this specification is merely an association relationship for describing associated objects, and represents that three relationships may exist, for example, A and/or B may represent three cases: A exists alone, both A and B exist, and B exists alone. In addition, the term “at least one” herein represents any one of a plurality or any combination of at least two of a plurality, for example, comprising at least one of A, B, or C, and may represent comprising any one or more elements selected from a set consisting of A, B, and C.

In addition, in order to better illustrate the present disclosure, numerous specific details are given in the following specific implementations. It will be understood by those skilled in the art that the present disclosure may be implemented even without some of the specific details. In some examples, methods, means, elements, and circuits well known to those skilled in the art are not described in detail, so as to highlight the subject matter of the present disclosure.

A static display scenario of a Graphics Processing Unit (GPU) may represent a scenario in which a display of a computer displays a static screen. The static screen may represent an image or a screen that does not change. The static screen may comprise a picture, an icon, an interface element, and the like.

The following uses an example in which the primary video memory in the GPU is a Graphics Double Data Rate (GDDR) memory for description. The GDDR memory is a high-performance Double Data Rate (DDR) memory specially designed for designing high-end graphics cards.

In a static display scenario of GPU, a display reads frame data from a GDDR memory of the GPU at a preset refresh rate and displays it. The maximum time interval between two consecutive reading of frame data by the display is referred to as a Vertical Blank (VBlank) interval.

The power consumption of the GDDR memory accounts for a relatively large proportion of the overall power consumption of the GPU. Because a static display scenario has a relatively low requirement on a bandwidth of the GDDR memory, the overall power consumption of GPU can be reduced by reducing the clock frequency of GDDR memory. However, GDDR memory requires that adjustments to its clock frequency must be made while it is in an idle state. That is, the clock frequency of the GDDR memory can be adjusted only when the GDDR memory is in the idle state. The maximum available idle time is the VBlank interval. In a case that the plurality of displays perform static display (that is, the plurality of displays read frame data from the GDDR memory of the GPU at corresponding refresh rates and display the frame data), time points at which each display enters the VBlank interval may be inconsistent, resulting in that a time length in which the plurality of displays are simultaneously in an idle state may be less than the VBlank interval.

In the related art, two solutions are mainly used to reduce the clock frequency of the GDDR memory.

The first solution is to adopt a GPU with fast GDDR frequency adjustment capability. The GDDR frequency adjustment represents adjusting the clock frequency of the GDDR memory, and correspondingly, the GDDR frequency adjustment capability represents a capability of adjusting the clock frequency of the GDDR memory. In this solution, the clock frequency of the GDDR memory is reduced in the VBlank interval. The VBlank interval may differ based on different the display and a configuration of refresh rate, and is usually 500-600 microseconds. In a multi-display scenario, it is necessary to adjust the clock frequency of the GDDR memory only after multiple displays all enter the VBlank interval. Some GPUs may perform a special GDDR frequency adjustment design, so that the GPU has a fast GDDR frequency adjustment capability. This enables the GPU to complete the adjustment of the clock frequency of the GDDR memory within the VBlank interval, thereby meeting a power consumption requirement for the GDDR memory in a low-power scenario.

The second solution is to use system memory as a buffer space of frame data. In this solution, the frame data is backed up in the system memory, and the display is controlled to read the frame data from the system memory and display the frame data, so that the GDDR memory is in an idle state, thereby enabling the operation of reducing the clock frequency of the GDDR memory to be performed when the GDDR memory is in the idle state. After the clock frequency of the GDDR memory is reduced, the display is controlled to read the frame data from the GDDR memory and display the frame data.

In the first solution, since the VBlank interval is relatively short and not fixed, and the time points at which the plurality of displays enter the VBlank interval may be inconsistent, the clock frequency of the GDDR memory needs to be adjusted only after the plurality of displays all enter the VBlank interval. Consequently, the adjustment to the clock frequency of the GDDR memory must be completed within a very short time, which imposes strict design requirements on the GPU chip. Therefore, most GPU chips cannot adopt the first solution to adjust the clock frequency of the GDDR memory.

In a second solution, the access to the frame data by the display from the system memory depends on many external factors, comprising a bandwidth of a Peripheral Component Interconnect-express (PCIe) bus, a bandwidth of the system memory, and the like. When the configuration of the system hardware is relatively low, for example, when the bandwidth of the PCIe bus and/or the bandwidth of the system memory cannot meet the bandwidth requirement of the static display of the display, there may be a screen flickering problem on the display.

In order to solve the technical problems similar to those described above, an embodiment of the present disclosure provides a method for static display control for GPU. By copying frame data in a first video memory to a second video memory in response to entering a static display scenario, reading the frame data from the second video memory and displaying the frame data, reducing a clock frequency of the first video memory, and reading the frame data from the first video memory and displaying the frame data in response to completion of an adjustment to the clock frequency of the first video memory, this method enables the first video memory to be in an idle state in a process of reading the frame data from the second video memory. Therefore, the clock frequency of the first video memory can be reduced to reduce the overall power consumption of the GPU. In the embodiments of the present disclosure, the clock frequency of the first video memory does not need to be adjusted in the VBlank interval, that is, there is sufficient time to adjust the clock frequency of the video memory, so that the requirements on the GPU chip can be reduced, and the flow of frequency adjustment of the first video memory does not need to be specially designed. In addition, in the embodiments of the present disclosure, the frame data in the first video memory is copied to the second video memory in the same GPU, and the frame data is read from the second video memory in the GPU in the process of adjusting the clock frequency of the first video memory, thereby reducing the dependence on external factors (such as the bandwidth of the PCIe bus and the bandwidth of the system memory) of the GPU, that is, reducing the dependence on the system hardware configuration, thereby reducing the probability of screen flickering of the display.

The method for static display control for GPU provided by the embodiments of the present disclosure will be described in detail below with reference to the accompanying drawings.

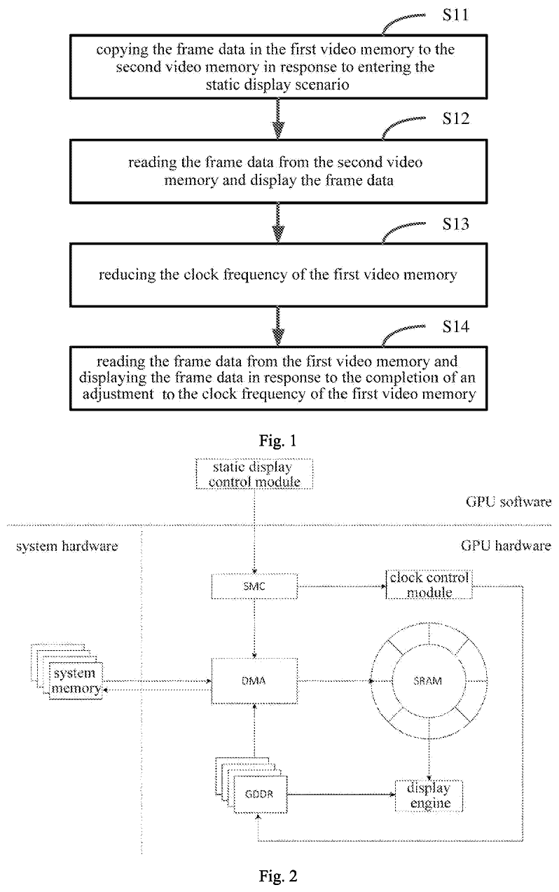

FIG. 1 shows a flowchart of a method for static display control for GPU provided by the embodiments of the present disclosure. In a possible implementation, the execution subject of the method for the static display control for GPU can be a device for static display control for GPU. For example, the method for the static display control for GPU may be executed by a terminal apparatus, a server, or another electronic apparatus. The terminal apparatus may be an User Equipment (UE), a mobile apparatus, a user terminal, a terminal, a cellular phone, a cordless phone, a Personal Digital Assistant (PDA), a handheld apparatus, a computing apparatus, a vehicle-mounted apparatus, a wearable apparatus, or the like. In some possible implementations, the method for static display control for GPU may be implemented by a processor invoking computer-readable instructions stored in a memory. As shown in FIG. 1, the method for the static display control for GPU comprises steps S11 to S14.

In step S11, in response to entering a static display scenario, the frame data in a first video memory is copied to a second video memory;

In step S12, the frame data is read from the second video memory and displayed;

In step S13, the clock frequency of the first video memory is reduced;

In step S14, in response to completion of an adjustment to the clock frequency of the first video memory, the frame data is read from the first video memory and displayed.

In a possible implementation, in a case of not being in the static display scenario, it may be determined to enter the static display scenario in response to the duration of displaying the static screen reaching the preset duration; and in a case of being in the static display scenario, it may be determined to exit the static display scenario in response to the displayed screen changing.

For example, in the case of being in the dynamic display scenario, it may be determined to enter the static display scenario in response to the duration of displaying the static screen reaching the preset duration; and in the case of being in the static display scenario, it may be determined to exit the static display scenario and enter the dynamic display scenario in response to the displayed screen changing. The dynamic display scenario may also be referred to as a normal working display scenario, a normal display scenario, or the like, which is not limited herein. In a dynamic display scenario, frame data may be read from the first video memory and displayed. For example, in a dynamic display scenario, a display engine may read frame data from a first video memory, and provide the frame data to the display for display.

In this implementation, the moment for entering and exiting the static display scenario may be determined (that is, the time point of entering and exiting the static display scenario may be determined) by GPU software or GPU hardware. The entering and exiting the static display scenario represents entering the static display scenario and exiting the static display scenario.

In a possible implementation, the static display control module in the GPU software may be used to determine an moment for entering and exiting the static display scenario. The static display control module may also be referred to as a GPU idle control logic module, an idle control logic module, a low-power control module, a GPU low-power control logic module, or the like, which is not limited herein.

In a possible implementation, the static display control module may be further configured to: in response to entering the static display scenario, send a notification message of entering the static display scenario to a system management controller (SMC), and in response to exiting the static display scenario, send a notification message of exiting the static display scenario to the system management controller. That is, the static display control module may notify the system management controller to enter the static display scenario in response to entering the static display scenario, and notify the system management controller to exit the static display scenario in response to exiting the static display scenario.

In a possible implementation, the system management controller may run firmware code, and undertake a task of a flow management of the static display control solution for the GPU. The system management controller may also be referred to as a system management unit, a system management module, or the like, which is not limited herein.

In a possible implementation, the system management controller may communicate with the GPU software, and receive, from the GPU software, the notification message for entering the static display scenario and the notification message for exiting the static display scenario. For example, the system management controller may communicate with the static display control module, and receive the notification message for entering the static display scenario and the notification message for exiting the static display scenario that are sent by the static display control module.

In the embodiments of the present disclosure, the first video memory may refer to a primary video memory in the GPU. For example, the first video memory may be a GDDR memory, which is not limited herein.

In the embodiments of the present disclosure, the frame data in the first video memory may be copied to the second video memory in the same GPU in response to entering the static display scenario. The first video memory and the second video memory are different video memories in the same GPU.

In a possible implementation, the system management controller may copy the frame data in the first video memory to a second video memory in the GPU by a Direct Memory Access (DMA) module in response to entering a static display scenario. The DMA module may be configured to transfer data at a high speed.

In the embodiments of the present disclosure, the second video memory may be a Static Random Access Memory (SRAM), a Low Power Double Data Rate (LPDDR) memory, etc. in the GPU, which is not limited herein.

In a possible implementation, the frame data in the first video memory may be copied to at least one second video memory in the GPU in response to entering a static display scenario.

As an example of this implementation, the frame data in the first video memory may be copied to the SRAM in the GPU in response to entering a static display scenario. For example, the frame data in the first video memory may be copied to the SRAM in the GPU in response to entering the static display scenario and the data volume of the frame data in the first video memory being less than or equal to the capacity of the SRAM.

As another example of this implementation, the frame data in the first video memory may be copied to the LPDDR memory in the GPU in response to entering a static display scenario. For example, all frame data in the first video memory may be copied to the LPDDR memory in the GPU in response to entering a static display scenario.

As another example of this implementation, the frame data in the first video memory may be copied to the SRAM and the LPDDR memory in the GPU in response to entering a static display scenario. For example, in response to entering the static display scenario and the data volume of the frame data in the first video memory being greater than the capacity of the SRAM, a portion of the frame data in the first video memory may be copied to the SRAM, and another portion of the frame data may be copied to the LPDDR, wherein the data volume of the frame data copied to the SRAM may be equal to the capacity of the SRAM.

In a possible implementation, the frame data in the first video memory may be copied to the second video memory and the system memory in response to entering a static display scenario. For example, in response to entering the static display scenario and the data volume of the frame data in the first video memory being greater than the capacity of the SRAM, a portion of the frame data in the first video memory may be copied to the SRAM, and another portion of the frame data may be copied to the system memory, wherein the data volume of the frame data copied to the SRAM is equal to the capacity of the SRAM.

In a possible implementation, the copying the frame data in the first video memory to the second video memory in response to entering the static display scenario comprises: acquiring the number of displays in response to entering the static display scenario; determining the second video memory based on the number of displays; and copying the frame data in the first video memory to the second video memory.

As an example of this implementation, the number of displays may be acquired by the static display control module.

In this implementation, as the number of displays increases, the data volume of the frame data in the first video memory also increases correspondingly, and capacities of different memories in the GPU are different, and therefore, an appropriate second video memory may be determined in the GPU based on the number of displays.

In this implementation, in response to entering the static display scenario, the number of displays is acquired, the second video memory is determined based on the number of displays, and the frame data in the first video memory is copied to the second video memory, thereby helping to balance the overall power consumption of the GPU and visual effects of the displays (to reduce screen flickering).

As an example of this implementation, the determining the second video memory according to the number of the displays comprises: in response to the number of displays falling within a preset range of number, determining the second video memory as the static random access memory in the GPU.

The number of displays is a positive integer, and any number of displays falling within the preset range of number is less than any number of displays not falling within the preset data range.

In this example, in response to the number of displays falling within the preset range of number, the second video memory is determined as the SRAM in the GPU, so that when the number of displays is relatively small, the SRAM in the GPU can be used as the buffer space for displaying, thereby reducing the overall power consumption of the GPU.

For example, the preset range of number is [1,1].

In this example, when the number of displays is 1, the SRAM in the GPU may be determined as the second video memory, and when the number of displays is greater than 1, the LPDDR memory in the GPU may be determined as the second video memory. This helps to balance the overall power consumption of the GPU and visual effects of the displays.

A value of the preset range of number may be flexibly set based on at least one of a capacity of the SRAM in the GPU, a frame size of a static screen in a static display scenario, or the like, which is not limited herein. For example, the preset range of number may alternatively be [1,2] or the like.

In an example, copying the frame data in the first video memory to the second video memory comprises: copying all the frame data in the first video memory to the static random access memory in response to the data volume of the frame data in the first video memory being less than or equal to the capacity of the static random access memory.

In this example, all the frame data in the first video memory is copied to the SRAM in response to the data volume of the frame data in the first video memory being less than or equal to the capacity of the SRAM, so that when the number of displays is relatively small, the frame data in the first video memory can be backed up from the SRAM in the GPU. This can reduce the overall power consumption of the GPU, and can reduce the dependence on external factors (such as the bandwidth of the PCIe bus and the bandwidth of the system memory) of the GPU, that is, it can reduce the dependence on the system hardware configuration, thereby reducing the probability of screen flickering of the displays.

In an example, copying frame data in a first video memory to the second video memory comprises: copying first frame data in the first video memory to the static random access memory in response to a data volume of the frame data in the first video memory being greater than a capacity of the static random access memory, wherein a data volume of the first frame data is equal to the capacity of the static random access memory; and the method further comprises: copying second frame data in the first video memory to a system memory.

In this example, the system memory may also be referred to as CPU memory. The system memory may adopt Double Data Rate (DDR) memory or the like, which is not limited herein.

In this example, when the data volume of the frame data in the first video memory is greater than the capacity of the SRAM, a portion of the frame data in the first video memory may be copied to the SRAM, and another portion of the frame data may be copied to the system memory. The frame data in the first video memory copied to the SRAM may be referred to as first frame data, and a data volume of this portion of frame data may be equal to a capacity of the SRAM; and the frame data in the first video memory copied to the system memory may be referred to as second frame data.

In this example, in response to the data volume of the frame data in the first video memory being greater than the capacity of the SRAM, a portion of the frame data in the first video memory is copied to the SRAM, and another portion of the frame data is copied to the system memory, wherein the data volume of the frame data copied to the SRAM is equal to the capacity of the SRAM, so that when the number of displays falls within the preset range of number, there is no need to use LPDDR memory, thereby helping to reduce the overall power consumption of the GPU.

In an example, after copying a portion of the frame data in the first video memory to the static random access memory, and copying another portion of the frame data to the system memory, the method further comprises: copying second frame data in the system memory to the static random access memory in response to the first frame data in the static random access memory being read out.

In this example, as the first frame data in the SRAM is read out, the second frame data in the system memory may be sequentially copied to the SRAM.

In this example, in response to the first frame data in the SRAM being read out, the second frame data in the system memory is copied to the SRAM, thereby reducing the probability of screen flickering of the displays.

In an example, the static random access memory adopts a data structure of a ring buffer.

The ring buffer may also be referred to as a circular queue, a circular queue, a cyclic buffer, a circular buffer, a ring buffer device, or the like, which is not limited herein.

In this example, a read pointer and a write pointer may be set for the SRAM, wherein the read pointer may point to the space where the frame data stored first in the SRAM is located, and the write pointer may point to the space in which the frame data is to be written. If the space pointed by the write pointer in the SRAM is occupied, it may be determined that the SRAM is full, and the frame data in the system memory can be stored in the space pointed by the write pointer only after the frame data in the space pointed by the write pointer is read out. The head and tail spaces of the SRAM are connected.

In this example, the data structure of the ring buffer is adopted by the SRAM, which helps to improve the speed and reliability of frame data transmission.

As an example of this implementation, the determining the second video memory according to the number of the displays comprises: in response to the number of the displays not falling within a preset range of number, determining the second video memory as the LPDDR memory in the GPU.

In this example, when the number of displays does not fall within the preset range of number, the LPDDR memory may be used as the buffer space for display. The number of displays is a positive integer, and any number of displays falling within the preset range of number is less than any number of displays not falling within the preset data range.

In this example, in response to the number of displays not falling within the preset range of number, the second video memory is determined as the LPDDR memory in the GPU, so that when the number of displays is relatively large, the frame data in the first video memory is backed up through the LPDDR memory with a relatively large capacity in the GPU. This can reduce the dependence on external factors (such as the bandwidth of the PCIe bus and the bandwidth of the system memory) of the GPU, that is, it can reduce the dependence on the system hardware configuration, thereby reducing the probability of screen flickering of the displays.

As an example of this implementation, the static display control module may acquire the number of displays in response to entering a static display scenario. The static display control module may send a notification message for entering a static display scenario for a single display to the system management controller in response to the number of displays being 1; and the static display control module may send a notification message for entering a static display scenario for multiple displays to the system management controller in response to the number of displays being greater than 1.

In this example, the system management controller may determine, in response to the notification message for entering the static display scenario for the single display, whether the data volume of the frame data in the first video memory is less than or equal to the capacity of the SRAM. If the data volume of the frame data in the first video memory is less than or equal to the capacity of the SRAM, all the frame data in the first video memory may be copied to the SRAM. If the data volume of the frame data in the first video memory is greater than the capacity of the SRAM, a portion of the frame data in the first video memory may be copied to the SRAM, and another portion of the frame data may be copied to the system memory, wherein the data volume of the frame data copied to the SRAM is equal to the capacity of the SRAM.

In this example, the system management controller may copy the frame data in the first video memory to the LPDDR memory in response to a notification message of entering a static display scenario for multiple displays.

As an example of this implementation, when the number of displays falls within the preset range of number, the electronic apparatus may be configured with only SRAM and without LPDDR, thereby reducing the overall power consumption of the GPU.

As an example of this implementation, when the number of displays does not fall within the preset range of number, the electronic apparatus may be configured with the LPDDR, so that a relatively large amount of frame data corresponding to displays can be stored by a LPDDR memory with a relatively large capacity.

In another possible implementation, the frame data in the first video memory may be copied to the SRAM in response to entering a static display scenario and a data volume of the frame data in the first video memory being less than or equal to a capacity of the SRAM. In this implementation, whether the number of displays falls within the preset range of number may not be considered.

In another possible implementation, in response to entering the static display scenario and the data volume of the frame data in the first video memory being greater than the capacity of the SRAM, the first frame data in the first video memory may be copied to the SRAM, and the second frame data in the first video memory may be copied to the system memory. In this implementation, whether the number of displays falls within the preset range of number may not be considered.

In another possible implementation, the frame data in the first video memory may be copied to the LPDDR memory in response to entering a static display scenario. In this implementation, whether the number of displays falls within the preset range of number may not be considered.

In another possible implementation, copying frame data in the first video memory to the second video memory in response to entering the static display scenario comprises: acquiring a data volume of the frame data in the first video memory in response to entering the static display scenario; determining the second video memory based on the data volume of the frame data in the first video memory; and copying the frame data in the first video memory to the second video memory.

For example, if the data volume of the frame data in the first video memory is less than or equal to the capacity of the SRAM in the GPU, the SRAM in the GPU may be determined as the second video memory, and the frame data in the first video memory is copied to the SRAM.

For another example, if the data volume of the frame data in the first video memory is greater than the capacity of the SRAM in the GPU, the LPDDR memory in the GPU may be determined as the second video memory, and the frame data in the first video memory is copied to the LPDDR memory.

In the embodiments of the present disclosure, after the frame data in the first video memory is copied to the second video memory, the frame data may be read from the second video memory and displayed.

In a possible implementation, after copying the frame data in the first video memory to the second video memory, the system management controller may configure the display engine to read the frame data from the second video memory and display the frame data. For example, when the second video memory is an SRAM, the system management controller may configure the display engine to read frame data from the SRAM and display the frame data. For another example, when the second video memory is a LPDDR memory, the system management controller may configure the display engine to read frame data from the LPDDR memory and display the frame data.

In the embodiments of the present disclosure, in the process of reading the frame data from the second video memory and displaying the frame data, the first video memory is in an idle state, so the clock frequency of the first video memory can be adjusted.

In a possible implementation, the system management controller may adjust the clock frequency of the first video memory by the clock control module. For example, the system management controller may reduce the clock frequency of the first video memory by the clock control module. For another example, the system management controller may increase the clock frequency of the first video memory by the clock control module.

In the embodiments of the present disclosure, after an adjustment to the clock frequency of the first video memory is completed, the frame data may be read from the first video memory and displayed. In a possible implementation, the system management controller may configure the display engine to read the frame data from the first video memory and display the frame data in response to completion of an adjustment to the clock frequency of the first video memory.

The method for the static display control for GPU provided by the embodiments of the present disclosure may be applied to technical fields such as GPU, GDDR, and low power consumption, which is not limited herein.

The method for the static display control for GPU provided by the embodiments of the present disclosure will be described below through specific application scenarios.

FIG. 2 shows a schematic diagram of an application scenario of a single display in a method for static display control for GPU provided by the embodiments of the present disclosure. As shown in FIG. 2, in an application scenario of a single display, a method for static display control for GPU may be implemented by GPU software, GPU hardware, and system hardware. The system hardware may also be referred to as CPU hardware.

The GPU software may comprise a static display control module, the GPU hardware may comprise an SMC, a clock control module, a DMA module, a SRAM, a GDDR memory, and a display engine, and the system hardware may comprise system memory.

The static display control module may be configured to determine an moment for entering and exiting the static display scenario (that is, determine a time point for entering and exiting the static display scenario), and may notify, in response to entering the static display scenario, the SMC of the entering, and notify, in response to exiting the static display scenario, the SMC of the exiting.

The SMC may communicate with the static display control module, and receive the notification message of entering the static display scenario and the notification message of exiting the static display scenario that are sent by the static display control module. The SMC may also configure a clock control module, to adjust a clock frequency of the GDDR memory by the clock control module. The SMC may also configure parameters of the DMA module. The SMC may also coordinate the transmission of frame data between the system memory and the SRAM in the GPU.

The clock control module may be configured to adjust a clock frequency of the GDDR memory.

The DMA module may be configured to copy the frame data in the GDDR memory to the SRAM and the system memory, and copy the frame data in the system memory to the SRAM.

The SRAM and system memory may be configured to back up frame data for static display in the GDDR memory.

GDDR memory may be configured to store frame data needed for display on a display.

The display engine may read the frame data from the GDDR memory or SRAM and provide the frame data to the display for display.

The following is an introduction to a basic static display control flow in an application scenario of a single display.

S1: In a dynamic display scenario, the display may read frame data from a GDDR memory, and provide the frame data to the display for display.

S2: The static display control module may send a notification message of entering the static display scenario for the single display to the SMC, in response to monitoring that the entering of the static display scenario for the single display.

S3: The SMC may determine, in response to the notification message of entering the static display scenario for a single display, whether the data volume of the frame data in the GDDR memory is less than or equal to the capacity of the SRAM (SRAM size). If the data volume of the frame data in the GDDR memory is less than or equal to the capacity of the SRAM, all the frame data in the GDDR memory may be copied to the SRAM. If the data volume of the frame data in the GDDR memory is greater than the capacity of the SRAM, a portion of the frame data in the GDDR memory may be copied to the SRAM, and another portion of the frame data may be copied to the system memory, wherein the data volume of the frame data copied to the SRAM is equal to the capacity of the SRAM.

S4: The SMC may configure the display engine to read the frame data from the SRAM and display the frame data. When a portion of the frame data in the GDDR memory is copied to the system memory, the frame data in the system memory may be copied to the free space of the SRAM in response to the frame data in the SRAM being read out.

S5: The SMC may reduce the clock frequency of the GDDR memory by the clock control module.

S6: The SMC may configure the display engine to read the frame data from the GDDR memory and display the frame data in response to completion of an adjustment to the clock frequency of the GDDR memory.

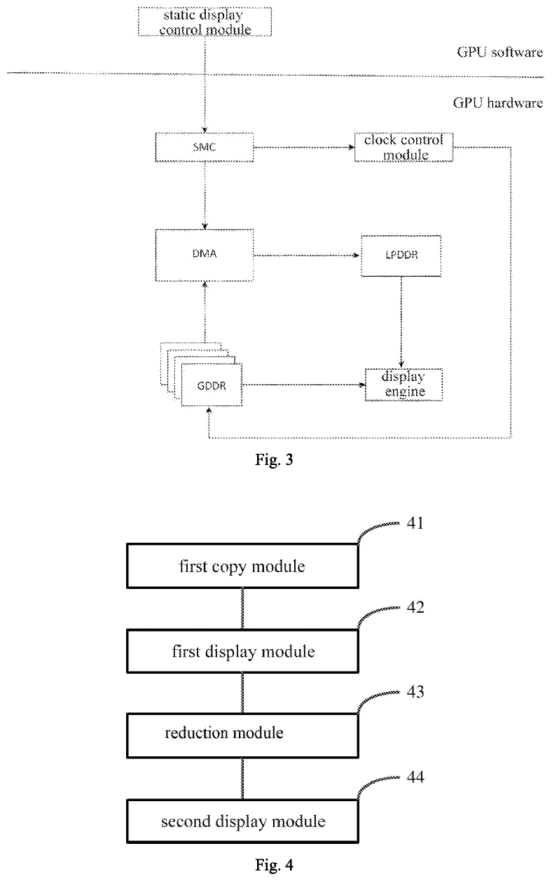

FIG. 3 shows a schematic diagram of an application scenario of multiple displays in a method for static display control for GPU provided by the embodiments of the present disclosure. Multiple displays may represent more than two displays. As shown in FIG. 3, in an application scenario of multiple displays, a method for static display control for GPU may be implemented by GPU software and GPU hardware.

The GPU software may comprise a static display control module, and the GPU hardware may comprise an SMC, a clock control module, a DMA module, a LPDDR memory, a GDDR memory, and a display engine.

The static display control module may be configured to determine an moment for entering and exiting the static display scenario (that is, determine a time point for entering and exiting the static display scenario), and may notify, in response to entering the static display scenario, the SMC of the entering, and notify, in response to exiting the static display scenario, the SMC of the exiting.

The SMC may communicate with the static display control module, and receive the notification message of entering the static display scenario and the notification message of exiting the static display scenario sent by the static display control module. The SMC may also configure a clock control module, to adjust a clock frequency of the GDDR memory by the clock control module. The SMC may also configure parameters of the DMA module.

The clock control module may be configured to adjust a clock frequency of the GDDR memory.

The DMA module may be configured to copy frame data in the GDDR memory to the LPDDR memory.

The LPDDR memory may be configured to back up frame data for static display in the GDDR memory.

GDDR memory may be configured to store frame data needed for display on a display.

The display engine may read the frame data from the GDDR memory or the LPDDR memory and provide the frame data to the display for display.

The following is an introduction to a basic static display control flow in an application scenario of multiple displays.

S1: In a dynamic display scenario, the display may read frame data from a GDDR memory, and provide the frame data to the display for display.

S2: The static display control module may send a notification message of entering the static display scenario for multiple displays to the SMC, in response to monitoring the entering of the static display scenario for the multi-display.

S3. The SMC may separately copy frame data of each display in the GDDR memory to the LPDDR in response to a notification message of entering a static display scenario for multiple displays.

S4. The SMC may configure the display engine to read the frame data from the LPDDR memory and display the frame data.

S5: The SMC may reduce the clock frequency of the GDDR memory by the clock control module.

S6: The SMC may configure the display engine to read the frame data from the GDDR memory and display the frame data in response to completion of an adjustment to the clock frequency of the GDDR memory.

It can be understood that the above each method embodiment mentioned in the present disclosure can be combined with each other to form a combined embodiment without departing from the principle and logic. For the sake of brevity, these combinations are not redundantly described herein. Those skilled in the art may understand that, in the foregoing method in the specific implementation, a specific execution order of the steps should be determined based on functions and possible internal logic of the steps.

In addition, the present disclosure also provides a device, an electronic apparatus, a computer-readable storage medium, and a computer program product for static display control for GPU, which can be used to implement any method for the static display control for GPU provided by the present disclosure. The corresponding technical solutions and technical effects can be referred to in the corresponding description of the method section, which will not be redundantly described herein.

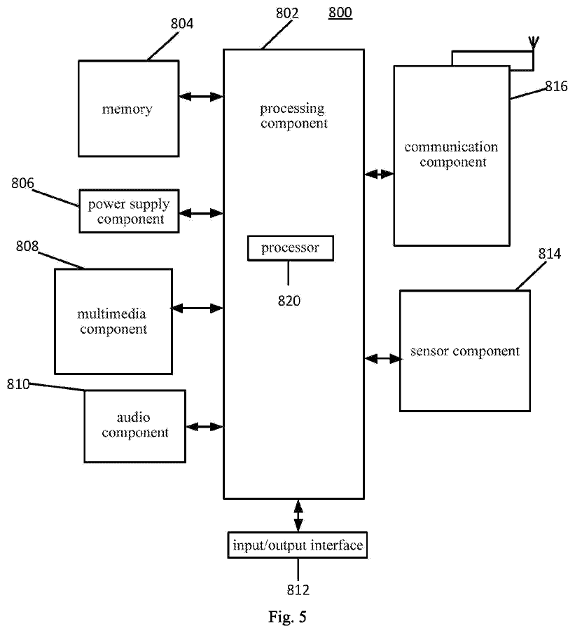

FIG. 4 shows a block diagram of a device for static display control for GPU provided by the embodiments of the present disclosure. As shown in FIG. 4, the static display control device for GPU comprises:
a first copy module 41 configured to copy frame data in a first video memory to a second video memory in response to entering a static display scenario;
a first display module 42 configured to read the frame data from the second video memory and display the frame data;
a reduction module 43 configured to reduce a clock frequency of the first video memory;
a second display module 44 is configured to read the frame data from the first video memory and display the frame data in response to completion of an adjustment to the clock frequency of the first video memory.

In a possible implementation, the first copy module 41 is configured to:
acquire a number of displays in response to entering a static display scenario;
determine a second video memory according to the number of the displays;
copy the frame data in the first video memory to the second video memory.

In a possible implementation, the first copy module 41 is configured to:
determine the second video memory as a static random access memory in the GPU in response to the number of displays falling within a preset range of number.

In a possible implementation, the first copy module 41 is configured to:
determine the second video memory as a low power double data rate (LPDDR) memory in the GPU in response to the number of displays not falling within a preset range of number.

In a possible implementation, the first copy module 41 is configured to:
copy all the frame data in the first video memory to the static random access memory in response to the data volume of the frame data in the first video memory being less than or equal to the capacity of the static random access memory.

In a possible implementation,
the first copy module 41 is configured to copy first frame data in the first video memory to the static random access memory in response to a data volume of the frame data in the first video memory being greater than a capacity of the static random access memory, wherein the data volume of the first frame data is equal to the capacity of the static random access memory; and
the device further comprises: a second copy module configured to copy the second frame data in the first video memory to a system memory.

In a possible implementation, the device further comprises:
a third copy module configured to copy second frame data in the system memory to the static random access memory in response to the first frame data in the static random access memory being read out.

In a possible implementation, the static random access memory adopts a data structure of a ring buffer.

An embodiment of the present disclosure provides a device for static display control for GPU, comprising a system management controller, a first video memory, a second video memory, a display engine, and a clock control module.

The system management controller is configured to copy frame data in a first video memory to a second video memory in response to the notification message of entering the static display scenario; and
the display engine is configured to read the frame data from the second video memory and display the frame data; and
the clock control module is configured to reduce a clock frequency of the first video memory; and
the display engine is further configured to read the frame data from the first video memory and display the frame data in response to completion of an adjustment to the clock frequency of the first video memory.

In a possible implementation, the second video memory comprises a static random access memory.

In a possible implementation, the static random access memory adopts a data structure of a ring buffer.

In a possible implementation, the second video memory comprises a LPDDR memory.

In a possible implementation, the device further comprises a direct memory access (DMA) module;
the system management controller is further configured to copy the frame data in the first video memory to the second video memory by the DMA module.

In a possible implementation, the device further comprises:
a static display control module configured to send a notification message of entering the static display scenario to the system management controller in response to entering the static display scenario.

In a possible implementation, the device further comprises:
a system memory configured to back up the frame data.

In some embodiments, the functions or modules included in the device provided by the embodiments of the present disclosure may be configured to execute the method described in the above method embodiments, and the specific implementation and technical effects thereof may refer to the description of the above method embodiments, which will not be redundantly described here for brevity.

An embodiment of the present disclosure further provides a computer-readable storage medium having stored thereon computer program instructions that, when executed by a processor, implement the above method. The computer-readable storage medium may be a non-volatile computer-readable storage medium, or may be a volatile computer-readable storage medium.

An embodiment of the present disclosure further provides a computer program, comprising computer-readable code, wherein when the computer-readable code runs in an electronic apparatus, a processor in the electronic apparatus executes the above method.

An embodiment of the present disclosure further provides a computer program product, comprising a computer-readable code or a non-volatile computer-readable storage medium carrying the computer-readable code, wherein when the computer-readable code runs in an electronic apparatus, a processor in the electronic apparatus executes the above method.

An embodiment of the present disclosure further provides an electronic apparatus, comprising: one or more processors; and a memory for storing executable instructions, wherein the one or more processors are configured to invoke the executable instructions stored in the memory to execute the above method.

The electronic apparatus may be provided as a terminal, a server, or an apparatus in another form.

FIG. 5 shows a block diagram of an electronic apparatus 800 provided by the embodiments of the present disclosure. For example, the electronic apparatus 800 may be a terminal such as a computer, a mobile phone, a digital broadcast terminal, a messaging apparatus, a game console, a tablet apparatus, a medical apparatus, exercise apparatus, or a personal digital assistant.

Referring to FIG. 5, the electronic apparatus 800 may comprise one or more of the following components: a processing component 802, a memory 804, a power supply component 806, a multimedia component 808, an audio component 810, an input/output interface 812, a sensor component 814, and a communication component 816.

The processing component 802 typically controls the overall operations of the electronic apparatus 800, such as the operations associated with display, telephone calls, data communications, camera operations, and recording operations. The processing component 802 may comprise one or more processors 820 to execute instructions to complete all or part of the steps in the above methods. In addition, the processing component 802 may comprise one or more modules to facilitate the interaction between the processing component 802 and other components. For example, the processing component 802 may comprise a multimedia module to facilitate the interaction between the multimedia component 808 and the processing component 802.

The memory 804 is configured to store various types of data to support the operations of the electronic apparatus 800. Examples of such data comprise instructions for any applications or methods operated on the electronic apparatus 800, contact data, phonebook data, messages, pictures, videos, etc. The memory 804 may be implemented by any type of volatile or non-volatile storage apparatus or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides power to various components of the electronic apparatus 800. The power supply component 806 may comprise a power supply management system, one or more power supplies, and any other components associated with the generation, management, and distribution of power for the electronic apparatus 800.

The multimedia component 808 comprises a screen providing an output interface between the electronic apparatus 800 and a user. In some embodiments, the screen may comprise a liquid crystal display (LCD) and a touch panel (TP). If the screen comprises a touch panel, the screen may be implemented as a touch screen to receive input signals from a user. The touch panel comprises one or more touch sensors to sense touches, slides, and gestures on the touch panel. The touch sensor may not only sense a boundary of a touch or slide action, but also detect the duration and pressure related to the touch or slide operation. In some embodiments, the multimedia component 808 comprises a front camera and/or a rear camera. The front camera and/or the rear camera may receive external multimedia data while the electronic apparatus 800 is in an operation mode, such as a photographing mode or a video mode. Each of the front camera and the rear camera may be a fixed optical lens system or have focal length and optical zoom capability.

The audio component 810 is configured to output and/or input audio signals. For example, the audio component 810 comprises a microphone (MIC) configured to receive external audio signals when the electronic apparatus 800 is in an operation mode, such as a call mode, a recording mode, and a voice recognition mode. The received audio signal may be further stored in the memory 804 or sent via the communication component 816. In some embodiments, the audio component 810 further comprises a speaker for outputting audio signals.

The input/output interface 812 provides an interface between the processing component 802 and peripheral interface modules, such as a keyboard, a click wheel, buttons, etc. These buttons may comprise, but are not limited to, a home button, a volume button, a start button, and a lock button.

The sensor component 814 comprises one or more sensors to provide state evaluation of various aspects of the electronic apparatus 800. For example, the sensor component 814 may detect an on/off state of the electronic apparatus 800, and relative positioning of components (e.g., the display and the keypad of the electronic apparatus 800). The sensor component 814 may also detect a change in position of one component of the electronic apparatus 800 or the electronic apparatus 800, a presence or absence of user contact with the electronic apparatus 800, an orientation or an acceleration/deceleration of the electronic apparatus 800, and a change in temperature of the electronic apparatus 800. The sensor component 814 may comprise a proximity sensor configured to detect the presence of nearby objects without any physical contact. The sensor assembly 814 may also comprise a light sensor, such as a complementary metal-oxide-semiconductor (CMOS) or charge-coupled device (CCD) image sensor, for use in imaging applications. In some embodiments, the sensor component 814 may also comprise an acceleration sensor, a gyroscope sensor, a magnetic sensor, a pressure sensor, or a temperature sensor.

The communication component 816 is configured to facilitate wired or wireless communication between the electronic apparatus 800 and other apparatus. The electronic apparatus 800 may access a wireless network based on a communication standard, such as a wireless network (Wi-Fi), a second-generation mobile communication technology (2G), a third-generation mobile communication technology (3G), a fourth-generation mobile communication technology (4G), a long-term evolution (LTE) of a universal mobile communication technology, a fifth-generation mobile communication technology (5G), or a combination thereof. In an exemplary embodiment, the communication component 816 receives a broadcast signal or broadcast related information from an external broadcast management system via a broadcast channel. In an exemplary embodiment, the communication component 816 further comprises a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic apparatus 800 may be implemented with one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, for executing the above methods.

In an exemplary embodiment, a non-volatile computer-readable storage medium is further provided, for example, a memory 804 comprising computer program instructions, wherein the computer program instructions may be executed by the processor 820 of the electronic apparatus 800 to complete the above methods.

The present disclosure may be a system, a method, and/or a computer program product. The computer program product may comprise a computer-readable storage medium having computer-readable program instructions stored thereon, the computer-readable program instructions for causing a processor to implement various aspects of the present disclosure.

The computer-readable storage medium can be a tangible apparatus that can hold and store instructions for use by an instruction execution apparatus. The computer-readable storage medium may be, for example, but is not limited to, an electronic storage apparatus, a magnetic storage apparatus, an optical storage apparatus, an electromagnetic storage apparatus, a semiconductor storage apparatus, or any suitable combination thereof. A non-exhaustive list of more specific examples of the computer-readable storage medium comprises: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded apparatus such as punch-cards or raised structures in a groove having instructions recorded thereon, and any suitable combination thereof. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing apparatus from a computer-readable storage medium or to an external computer or external storage apparatus via a network, for example, the Internet, a local area network, a wide area network and/or a wireless network. The network may comprise copper transmission cables, fiber optic transmission, wireless transmission, routers, firewalls, switches, gateway computers, and/or edge servers. A network adapter card or network interface in each computing/processing apparatus receives computer-readable program instructions from the network and forwards the computer-readable program instructions for storage in a computer-readable storage medium in each computing/processing apparatus.

Computer program instructions for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” language or similar programming languages. The computer-readable program instructions may execute entirely on the user computer, partly on the user computer, as a stand-alone software package, partly on the user computer and partly on a remote computer or entirely on the remote computer or server. In cases involving remote computers, the remote computer may be connected to the user computer through any type of network, comprising a local area network (LAN) or a wide area network (WAN), or may be connected to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer-readable program instructions by utilizing state information of the computer-readable program instructions to personalize and customize the electronic circuitry, thereby realizing various aspects of the present disclosure.

Various aspects of the present disclosure are described herein with reference to flowcharts and/or block diagrams of methods, devices (systems), and computer program products according to embodiments of the disclosure. It will be understood that each block of the flowcharts and/or block diagrams, and combinations of blocks in the flowcharts and/or block diagrams, can be implemented by computer-readable program instructions.

These computer-readable program instructions may be provided to a processor of a general purpose computer, special purpose computer, or other programmable data processing devices to produce a machine, such that the instructions, when executed via the processor of the computer or other programmable data processing devices, create a device for implementing the function/act specified in one or more blocks in the flowchart and/or block diagram. These computer-readable program instructions may also be stored in a computer-readable storage medium, and can cause a computer, a programmable data processing device, and/or other apparatus to function in a particular manner, such that the computer-readable medium having instructions stored therein comprises an article of manufacture comprising instructions which implement various aspects of the function/act specified in one or more blocks in the flowchart and/or block diagram.

The computer-readable program instructions may also be loaded onto a computer, other programmable data processing devices, or other apparatus to cause a series of operational steps to be executed on the computer, other programmable data processing devices or other apparatus to produce a computer implemented process, such that the instructions, executed on the computer, other programmable data processing devices, or other apparatus may implement the function/act specified in one or more blocks in the flowchart and/or block diagram.

The flowcharts and block diagrams in the accompanying drawings show the architecture, function, and operation of possible implementations of systems, methods, and computer program products according to various embodiments of the present disclosure. In this regard, each block in the flowcharts or block diagrams may represent a module, program segment, or portion of instructions, which comprises one or more executable instructions for implementing the specified logical function. In some alternative implementations, the functions noted in the blocks may occur in an order different from the order noted in the accompanying drawings. For example, two blocks in succession may, in fact, be executed substantially concurrently, or the blocks may sometimes be executed in the reverse order, depending upon the function involved. It will also be noted that each block of the block diagrams and/or flowchart, and combinations of blocks in the block diagrams and/or flowchart, can be implemented by special purpose hardware-based systems that execute the specified functions or acts, or combinations of special purpose hardware and computer instructions.

The computer program product may be further implemented by hardware, software, or a combination thereof. In an optional embodiment, the computer program product is embodied as a computer storage medium, and in another optional embodiment, the computer program product is embodied as a software product, such as a Software Development Kit (SDK).

The foregoing descriptions of the embodiments tend to emphasize differences between the embodiments, the same or similar parts may be referred to each other, and for brevity, details are not redundantly described herein.

If the technical solution of the embodiments of the present disclosure relates to personal information, before processing the personal information, the products to which the technical solution of the embodiments of the present disclosure is applied have explicitly informed the personal information processing rule and obtained personal self-consent. If the technical solution of the embodiments of the present disclosure relates to sensitive personal information, the products to which the technical solution of the embodiments of the present disclosure is applied have obtained personal consent alone before processing the sensitive personal information, and at the same time meet the requirement of “explicit consent”. For example, at a personal information acquisition device such as a camera, a clear and significant identifier is set to inform that the personal information acquisition range has been entered and the personal information will be acquired, and if the individual volunteers to enter the acquisition range, it is regarded as agreeing to acquire the personal information; or on a personal information processing device, in the case where an obvious identifier/information is used to inform a personal information processing rule, personal authorization is obtained by means of popup information or asking the individual to upload his/her personal information by himself/herself; wherein the personal information processing rule may comprise information such as a personal information processor, a personal information processing purpose, a processing manner and a type of processed personal information.

The descriptions of each embodiment of the present disclosure have been presented for purposes of illustration, but are not intended to be exhaustive or limited to the embodiments disclosed. Many modifications and variations will be apparent to those of ordinary skill in the art without departing from the scope and spirit of the described each embodiment. The terminology used herein was chosen to best explain the principles of each embodiment, the practical application or improvement over technologies found in the marketplace, or to enable others of ordinary skill in the art to understand each embodiment disclosed herein.

What is claimed is:

1. A method for static display control for Graphics Processing Unit (GPU), comprising:
copying frame data in a first video memory to a second video memory in response to entering a static display scenario;
reading the frame data from the second video memory and displaying the frame data;
reducing a clock frequency of the first video memory; and
reading the frame data from the first video memory and displaying the frame data in response to completion of an adjustment to the clock frequency of the first video memory.

2. The method according to claim 1, wherein copying frame data in the first video memory to the second video memory in response to entering the static display scenario comprises:
acquiring a number of displays in response to entering the static display scenario;
determining a second video memory based on the number of the displays; and
copying the frame data in the first video memory to the second video memory.

3. The method according to claim 2, wherein determining the second video memory based on the number of the displays comprises:
determining the second video memory as a static random access memory in the GPU in response to the number of displays falling within a preset range of number.

4. The method according to claim 2, wherein determining the second video memory based on the number of the displays comprises:
determining the second video memory as a low power double data rate (LPDDR) memory in the GPU in response to the number of displays not falling within a preset range of number.

5. The method according to claim 3, wherein copying the frame data in the first video memory to the second video memory comprises:
copying all the frame data in the first video memory to the static random access memory in response to a data volume of the frame data in the first video memory being less than or equal to a capacity of the static random access memory.

6. The method according to claim 3, wherein copying the frame data in the first video memory to the second video memory comprises:
copying first frame data in the first video memory to the static random access memory in response to a data volume of the frame data in the first video memory being greater than a capacity of the static random access memory, wherein the data volume of the first frame data is equal to the capacity of the static random access memory, and
the method also comprises copying a second frame data in the first video memory to a system memory.

7. The method according to claim 6, further comprising:
copying the second frame data in the system memory to the static random access memory in response to the first frame data in the static random access memory being read out.

8. The method according to claim 3, wherein the static random access memory adopts a data structure of a ring buffer.

9. A device for static display control for Graphics Processing Unit (GPU), comprising a system management controller, a first video memory, a second video memory, a display engine, and a clock control module,
wherein the system management controller is configured to copy frame data in a first video memory to a second video memory in response to a notification message of entering a static display scenario;
the display engine is configured to read the frame data from the second video memory and display the frame data;
the clock control module is configured to reduce a clock frequency of the first video memory; and
the display engine is further configured to read the frame data from the first video memory and display the frame data in response to completion of an adjustment to the clock frequency of the first video memory.

10. The device according to claim 9, further comprising a direct memory access (DMA) module, wherein
the system management controller is further configured to copy the frame data in the first video memory to the second video memory by the DMA module.

11. The device according to claim 9, further comprising:
a static display control module configured to send a notification message of entering the static display scenario to the system management controller in response to entering the static display scenario.

12. A non-transitory computer program product comprising computer-readable code, or a non-volatile computer-readable storage medium carrying computer-readable code, wherein when the computer-readable code runs in an electronic apparatus, a processor in the electronic apparatus is configured to:
copy frame data in a first video memory to a second video memory in response to entering a static display scenario;
read the frame data from the second video memory and displaying the frame data;
reduc a clock frequency of the first video memory; and
read the frame data from the first video memory and displaying the frame data in response to completion of an adjustment to the clock frequency of the first video memory.
